(19) United States
(12) Patent Application Publication
(10) Pub. No.: US 2006/0191973 A1
(43) Pub. Date: Aug. 31, 2006

(54) Nail stopper for a skew nailing gun

(75) Inventors: Jing Chi Chen, Taichung (TW); Yung Shuen Li, Taichung (TW)

Correspondence Address: CHARLES E. BAXLEY, ESQ., 90 JOHN STREET, THIRD FLOOR, NEW YORK, NY, 10038, US

(73) Assignee: Basso Industry Corp.

(21) Appl. No.: 11/067,143

(22) Filed: Feb. 25, 2005

(51) Int. Cl. B25C 5/06

(52) U.S. Cl. 227/123

(57) ABSTRACT

The present invention relates to a nail stopper for a skew nailing gun that is applicable to different types of skew nail, at a top end of the nailing groove on the muzzle of a nailing gun is formed a arc-shaped guiding groove correspondingly to the sharp end of various types of skew nail, so that the nailing gun with this guiding groove is suitable for the commonly-used various types of skew nails whose skew angle ranging from 31-37 degrees.

### BACKGROUND OF THE INVENTION

1. Field of the Invention

The present invention relates to a nail stopper for a skew nailing gun, and more particularly to a nail stopper for a skew nailing gun that is applicable to different types of skew nail.

2. Description of the Prior Arts

Nailing gun is an indispensable tool for doing different kinds of construction projects or some kinds of household works, and its practical applicability is one of the important elements for evaluating the market competitiveness of the nailing gun and its related products.

Different skew nails produced in the past only can be used in their corresponding skew nailing guns since the same sized skew nails produced by different producers may have different slant angles, different shapes and different heads), this is troublesome and stops the industrial development of the skew nailing gun.

Currently, a nailing gun applicable to various types of nail with the same diameter has been developed (as disclosed by TW Patent No. 248574), on the guiding board of the muzzle positioning structure of this nail gun is defined a V-shaped guiding groove, so that various types of nail with the same diameter (nails with head or without head) can be guided through the V-shaped guiding groove without changing the muzzle.

However, this nailing gun having the guiding groove is only suitable for the nails with a specific skew angle, otherwise, the nails having an unsuitable skew angle cannot be positioned properly in the guiding groove, this may lead to a breakdown of the nailing gun during operation.

The present invention has arisen to mitigate and/or obviate the afore-described disadvantages.

### SUMMARY OF THE INVENTION

The primary objective of the present invention is to provide a nail stopper for a skew nailing gun that is applicable to different types of skew nail, at a top end of the nailing groove on the muzzle of a nailing gun is formed a arc-shaped guiding groove correspondingly to the sharp end of various types of skew nail, so that the nailing gun with this guiding groove is suitable for the commonly-used various types of skew nails whose skew angle ranging from 31-37 degrees.

The secondary objective of the present invention is to provide a nail stopper for a skew nailing gun that can strike the nails more smoothly and stably by means of the arc-shaped guiding groove.

The present invention will become more obvious from the following description when taken in connection with the accompanying drawings, which show, for purpose of illustrations only, the preferred embodiments in accordance with the present invention.

### BRIEF DESCRIPTION OF THE DRAWINGS

FIG. 1 is a perspective view of a part of a nail stopper for a skew nailing gun in accordance with the present invention,

FIG. 2 is an amplified view of a part of a nail stopper for a skew nailing gun of FIG. 1;

FIG. 3 is a cross sectional view of showing an unloaded nail stopper for a skew nailing gun in accordance with the present invention;

FIG. 4 is an operational view of showing a nail stopper for a skew nailing gun in accordance with the present invention;

FIG. 5 is another operational view of showing a nail stopper for a skew nailing gun in accordance with the present invention;

FIG. 6 is comparative view of a nail stopper for a skew nailing gun in accordance with the present invention;

FIG. 7 shows a nail stopper for a skew nailing gun in accordance with another embodiment of the present invention.

### DETAILED DESCRIPTION OF THE PREFERRED EMBODIMENTS

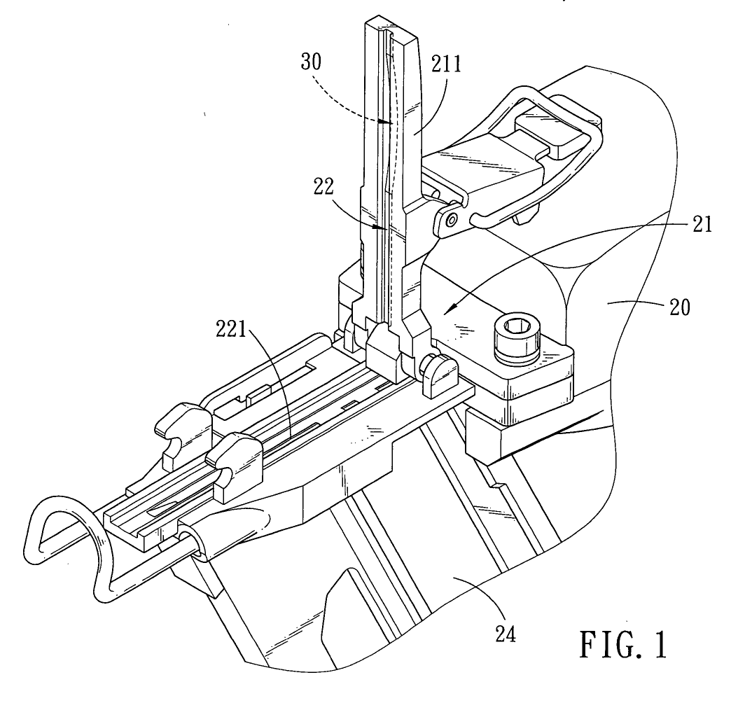

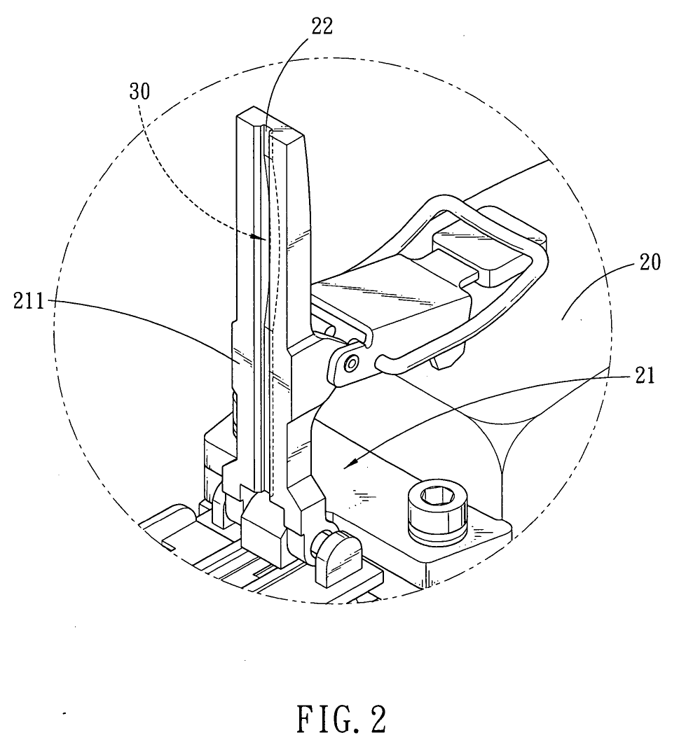

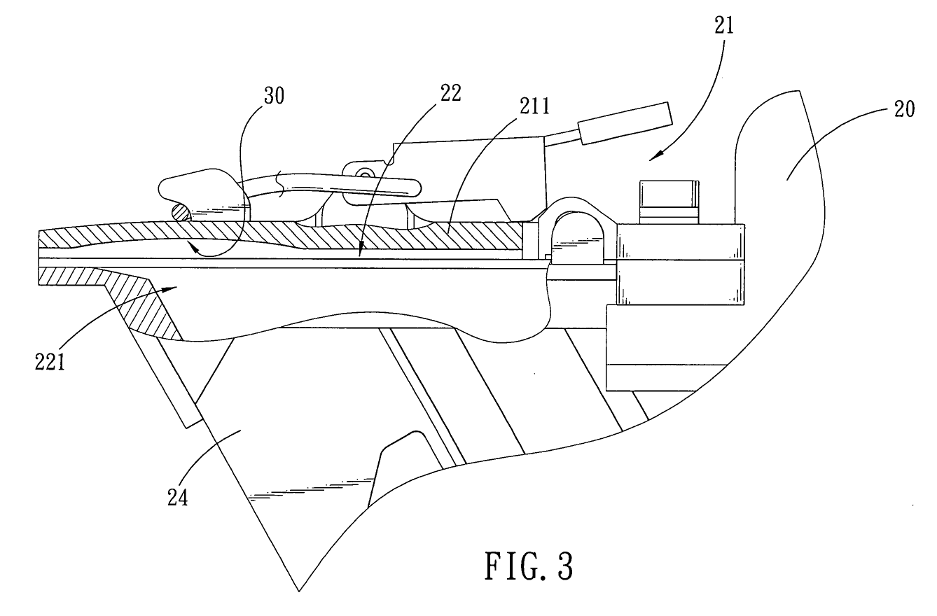

Referring to FIGS. 1-3, a nail stopper for a skew nailing gun is shown and is arranged in a nailing groove 22 which is formed on an upper cover 211 pivotally connected to muzzle 21 of a nailing gun 20, and a striker 23 reciprocates in the nailing groove 22 for striking the nails. At the bottom of the nailing groove 22 is formed a feeding hole 221 in communication with a magazine 24, and the magazine 24 uses spring to push the nails.

The upper cover 211 of the nailing gun 20 is provided at the top end of the nailing groove 22 with a guiding groove 30 which is arc-shaped correspondingly to the muzzle of the nailing gun 20 and is located toward an end of the nailing groove 30 at which the sharp end of the nails are positioned (the reference number of the nails varies in different embodiment).

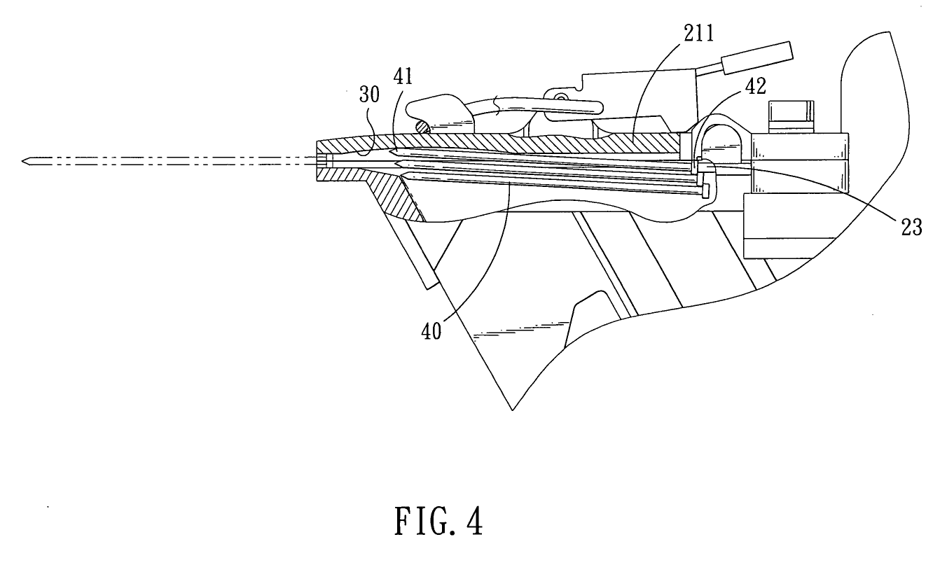

Referring to FIG. 4, which shows a commonly used skew nails 40 having a skew angle of 3°23′, when the skew nails 40 are pushed by the spring to the feeding hole 221 of the magazine 24, the sharp end of the skew nails 40 will enter the guiding groove 30. Since the guiding groove 30 is arc-shaped correspondingly to the muzzle 20 of the nailing gun in order to have an arc-shaped concave space capable accommodating different skew nails having various skew angles, the sharp end 41 of the skew nails 40 having a relative large skew angle can be positioned against the high portion of the top arc-shaped edge of the guiding groove 30, while the head 42 of the skew nails 40 is still kept in the nailing groove 22 so as to be rammed by the striker 23 more precisely. And this nailing structure of the nailing gun is suitable for the nails having a skew angle ranging from 34-36 degrees.

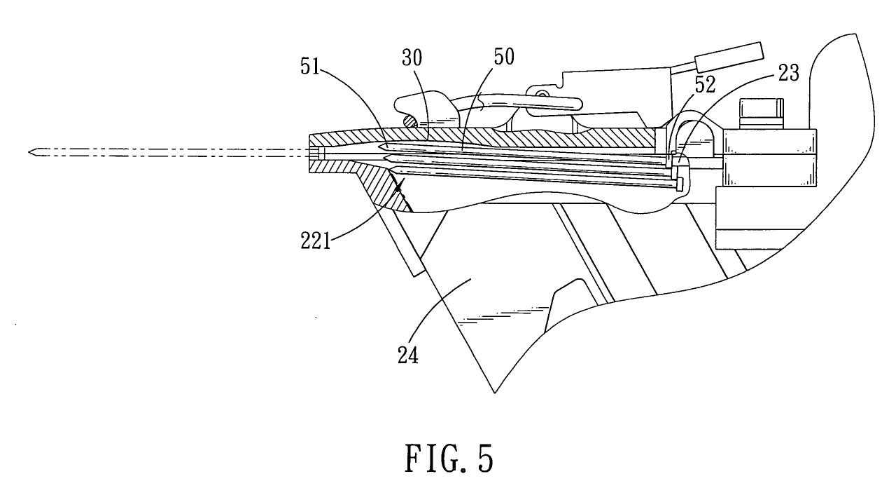

Referring to FIG. 5, which shows a commonly used skew nails 50 having a skew angle of 32°34′, when the skew nails 50 are pushed by the spring to the feeding hole 221 of the magazine 24, the sharp end of the skew nails 50 will enter the guiding groove 30. Since the guiding groove 30 is arc-shaped correspondingly to the muzzle 20 of the nailing gun in order to have an arc-shaped concave space capable accommodating different skew nails having various skew angles, the sharp end 51 of the skew nails 51 have a relative small skew angle can be positioned against the lower portion of the top arc-shaped edge of the guiding groove 30, while the head 52 of the skew nails 50 is still kept in the nailing groove 22 so as to be rammed by the striker 23 precisely. Therefore, this nailing structure of the nailing gun is suitable for the nails having a skew angle ranging from 31-34 degrees.

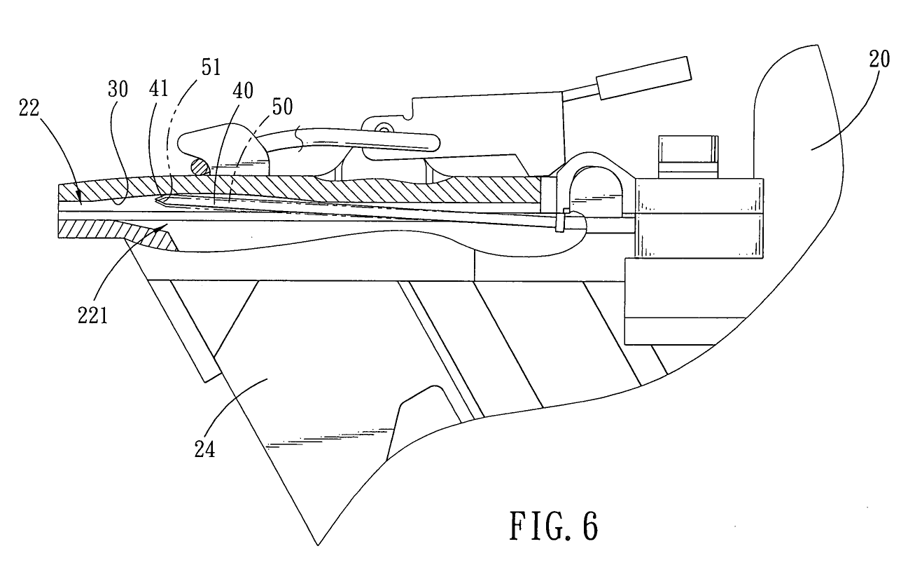

It is to be noted that, as shown in FIG. 6, the guiding structure of the nailing gun in accordance with the invention is not only suitable for different skew nails 40, 50 having different skew angles, but also the sharp end 41, 51 of the skew nails 40, 50 can be guided smoothly by the guiding groove 30 and driven stably into an object. Therefore, the striking process of this nailing gun can be carried out more smoothly as compared to conventional nailing guns.

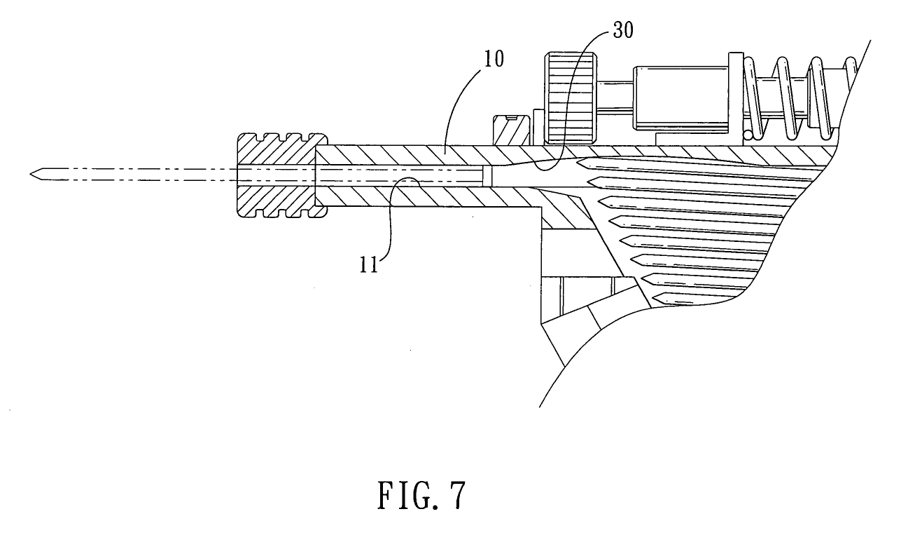

Referring to FIG. 7, besides being arranged in the nailing groove 22 of the muzzle 21 of the nailing gun 20 having the upper cover 211, the guiding structure also can be arranged in a nailing groove 11 of a nailing gun having a tubular muzzle 10, and the different nails also can be guided smoothly by the guiding groove 30 and driven stably into an object.

While we have shown and described various embodiments in accordance with the present invention, it should be clear to those skilled in the art that further embodiments may be made without departing from the scope of the present invention.

What is claimed is:

1. A nail stopper for a skew nailing gun comprising a guiding groove formed in a nailing groove of a nailing gun for guiding a striker to strike nails reciprocatingly along the nailing groove, at a bottom of the nailing groove formed a feeding hole in communication with a magazine of the nailing gun; wherein
the guiding groove is formed at a top end of a nailing groove which is arranged on an upper cover, the upper cover is pivotally connected to muzzle of the nailing gun, the guiding groove is arc-shaped correspondingly to the muzzle of the nailing gun and is located toward a sharp end of skew nails, the guiding groove has an arc-shaped concave space capable accommodating different skew nails having different skew angles, so that the sharp end of the skew nails are positioned in the guiding groove.

2. A nail stopper for a skew nailing gun comprising a guiding groove formed in a nailing groove of a nailing gun for guiding a striker to strike nails reciprocatingly along the nailing groove, at a bottom of the nailing groove formed a feeding hole in communication with a magazine of the nailing gun; wherein
the nailing gun has a integral formed tubular muzzle which is formed with a nailing groove, the guiding groove is formed at a top end of the nailing groove, the guiding groove is arc-shaped correspondingly to the muzzle of the nailing gun and is located toward a sharp end of skew nails, the guiding groove has an arc-shaped concave space capable accommodating different skew nails having different skew angles, so that the sharp end of the skew nails are positioned in the guiding groove.
